(19) United States
(12) Patent Application Publication
(10) Pub. No.: US 2025/0071165 A1
(43) Pub. Date: Feb. 27, 2025

(54) CHANNEL MANIFEST PUBLISHER

(71) Applicant: ARRIS Enterprises LLC, Horsham, PA (US)

(72) Inventors: David Alfred ROMRELL, Meridian, ID (US); Yixiang ZENG, Beaverton, OR (US); George Scott PINSON, Portland, OR (US); Li LIU, San Jose, CA (US)

(73) Assignee: ARRIS Enterprises LLC, Horsham, PA (US)

(21) Appl. No.: 18/812,909

(22) Filed: Aug. 22, 2024

Related U.S. Application Data
(60) Provisional application No. 63/534,266, filed on Aug. 23, 2023.

(51) Int. Cl. H04L 65/80; H04L 65/61

(52) U.S. Cl. CPC H04L 65/80; H04L 65/61

(57) ABSTRACT

A system for managing video content using a channel manifest publisher.

### CROSS REFERENCE TO RELATED APPLICATIONS

The present application claims priority to U.S. Provisional App. No. 63/534,266 filed Aug. 23, 2023, the content of which are incorporated herein by reference in its entirety.

### BACKGROUND

The subject matter of this application relates to a channel manifest publisher.

Traditional linear advertisement sales utilize a traffic and billing system that generates cable computerized management system files as schedules to fill advertisement spots into each advertisement break window into each channel that is defined jointly by network and zone. Advertisement back-office products consume these advertisement schedules and control video servers and video splicers to generate transport streams that are delivered over quadrature amplitude modulation (QAM) to set top boxes in each region.

Adaptive bitrate video is delivered over IP (Internet protocol) to hypertext transfer protocol (HTTP) streaming clients. Such clients often include, set top boxes, television, mobile phones, tablets, desktop computers, etc. A manifest manipulator device can perform dynamic targeted advertising that makes unique decisions for each streaming client for such advertisement placement. Such dynamic decisions have a different workflow from scheduled linear advertisements.

Traditional video delivery by a network operator is accomplished using MPEG encoded transport streams tuned into by set top boxes within a service group using quadrature amplitude modulation (QAM). The network source stream (aka source feed) typically comes from a content provider through a broadcast satellite distribution to an integrated receiver decoder (IRD). MPEG advertising splicers replace advertising breaks within the network source stream to generate a region-specific version of the transport stream for distribution as part of a channel line-up into an advertising zone which may consist of one or more QAM service groups. Traditional advertisement sales utilize a traffic and billing system to generate schedules to fill advertisement spots into each advertisement break window to target the set of viewers of the channel in each advertising zone.

### BRIEF DESCRIPTION OF THE DRAWINGS

For a better understanding of the invention, and to show how the same may be carried into effect, reference will now be made, by way of example, to the accompanying drawings, in which:

FIG. 1A and FIG. 1B illustrate exemplary network environment for video delivery.

FIG. 2 illustrates adaptive bitrate content provided to a cable network group.

FIG. 3 illustrates a fragment selection technique.

FIG. 4 illustrates an exemplary component diagram for video (or other content) delivery.

### SUMMARY OF THE INVENTION

Adaptive bitrate (ABR) video is delivered over IP (Internet protocol) to hypertext transfer protocol (HTTP) streaming clients. Such clients often include, set top boxes, television, mobile phones, tablets, desktop computers, streaming dongles, gaming consoles, etc. A manifest manipulator (e.g. Manifest Delivery Controller (MDC)) makes unique decisions for each streaming client for advertisement placement. Such dynamic decisions have a different advertisement decision workflow to support per-client addressable advertisements.

A channel manifest publisher (CMP) can be used to construct a dynamic grouping of targeted HTTP streaming clients. This can be combined with a manifest manipulator to allow a hybrid of unique per-client targeting decisions, regional group-based decisions with channel parity to a QAM advertising zone distribution, or other novel grouping of clients based on arbitrary combinations of client criteria (e.g., device type, interest profile, etc).

The CMP allows for efficient production of the channel manifest using a common advertising decision sharable across the set of ABR targeted client profiles. The CMP allows efficient cached distribution of the common manifests to reduce request rate and increase scale of the MDC. The common channel manifest supports aligned manifests for a multicast ABR (MABR) controller to distribute shared media segments into a home gateway device aligned with channel manifests used by devices in that region or household.

Through combination with a virtualized universal edge (VUE), the CMP can produce a source feed that is translated into MPEG transport streams targeted at a group for channel parity with traditional QAM based zoned distribution (e.g. replacing the traditional IRD and/or MPEG advertising splicers), or provide more refined and dynamic targeting such as per-service group distribution, or micro-targeted set top boxes or household profiles that are tuned into their specific source feed through switched digital video (SDV).

### DETAILED DESCRIPTION

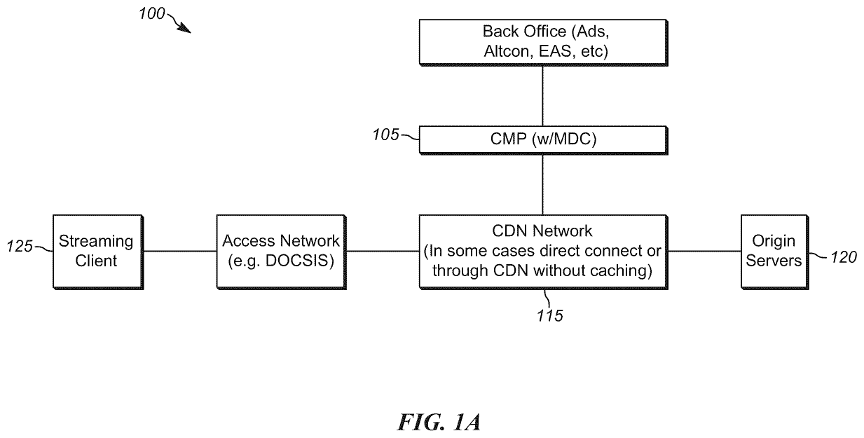

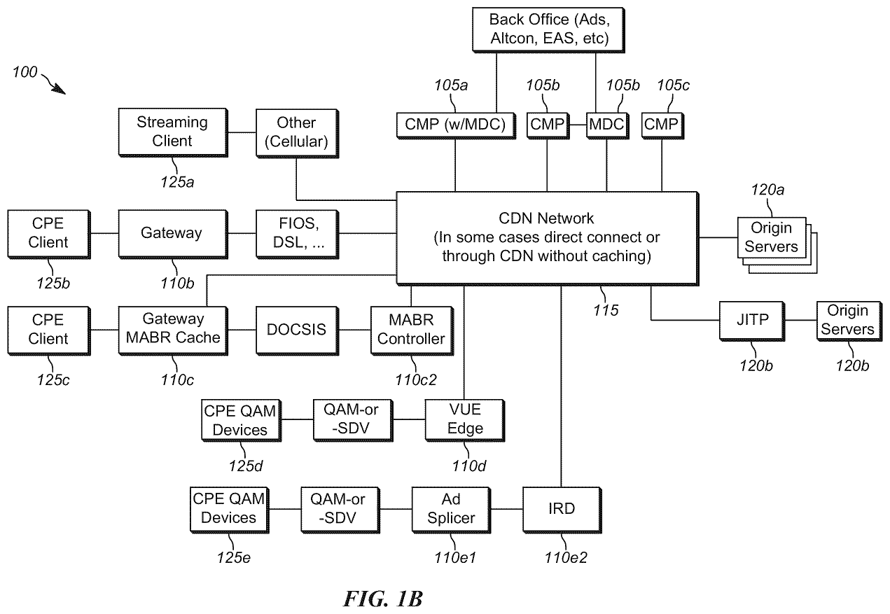

FIG. 1A and FIG. 1B are block diagrams illustrating an example network environment 100 operable to facilitate adaptive bitrate content delivery, such as TCP/IP over DOCSIS protocol that supports upstream and downstream communication and individual device addressing. In a preferred embodiment, the subscriber or end user selects the desired entertainment content to be played from a fulfilment system (not shown) and playback starts on a streaming client device 125 with the playback URI (i.e., uniform resource identifier) of the selected entertainment content along with attributes of this playback session as query parameters, http headers, and/or through other manner to convey or lookup information for the playback session. As a variation of this the fulfilment system may be a channel guide or channel line-up with a regional listing for the entertainment that can be selected.

As example, a streaming client 125a may provide the presentation of content through another network making the playback request to the CMP. As example of alternate embodiments, a CPE client device 125b may provide the presentation of content through a gateway device 110b making the playback request to the CMP. As another example, the CPE client device 125c and/or edge device 110c may be integrated with a multicast ABR (MABR) system that simultaneously makes regional requests to the CMP from a MABR controller 110c2 to broadcast the common media into the caches in the CPE client device 125c or the edge device 110c within that region. As another example embodiment, the CPE client device 125d may be a set top box or other presentation device that uses QAM or SDV distributed video packaged or encoded from an edge device 110d (e.g. VUE) acting on behalf of clients in making playback requests to the CMP.

As another example embodiment, a CPE client device 125e may be a set top box or other presentation device receiving video using QAM or SDV through an integrated receiver decoder (IRD) 110e2 that receives the upstream channel source feed from a CMP. This CMP may be within the service provider network or optionally within the provider network or an over-the-top streaming source that specialized content for this IRD and region distribution. The QAM and SDV distributions may optionally include a more traditional MPEG Advertising Splicer 110e1 to support a mixed solution with certain distributor ad break opportunities or other content specialization handled by the more traditional advertising and splicing solution.

The playback request may be addressed and routed to the CMP system 105 or through a CDN edge cache 115 or similar network components that may proxy or forward the requests to the CMP. Transactions are typically over HTTP, HTTPS, and TCP/IP but those skilled in the art could use other networks and transport methods for delivery of the playback requests and responses.

An advertisement back office may be integrated with a channel manifest publisher 105 (e.g., CMP). The channel manifest publisher 105 may retrieve an entertainment manifest (i.e., a manifest that is shared by a plurality of users) from a CDN (content delivery network) 115 and/or one or more origin servers 120. Using the provided session attributes the advertising system can target ad placement decisions for the playback session attributes and the CMP 105 may retrieve the associated advertisements' manifests from a CDN 115 and/or one or more origin servers 120. The CMP may include these targeted advertisements in the published manifests for the playback sessions. As another embodiment, the channel manifest publisher may retrieve a manifest that was produced from an upstream manifest manipulator 105b or just in time packager (JITP) 120b that may have filtered or adjusted the original entertainment manifest. The manifest manipulation and targeting functions can be chained as a cascading set of functions and refinements.

In general, the channel manifest publisher (CMP), applies to the delivery of customized content to individual customers. There are many products delivered to customers that can be customized en route. Examples are informative or entertaining audio and video products. These products typically feature a basic content value that can be enhanced by customization and may be subsidized via advertising. Both customization features enhance value in the video ecosystem. In the first case, the content can be localized and therefore more relevant to viewers. In the second case, ads can be inserted that are more impactful to viewers and generate more value for content owners and deliver greater efficiency for advertisers. These customization features are often accomplished via the same computationally intensive processes. Customization may also be the result of program substitution with alternate content such as during a sports blackout where alternate content substitutes the game in the restricted regions, or during an emergency alert that may substitute the regular programming in the impacted regions. In this manner, individualized adaptive bit rate streams may be provided to individual client players, each of which may include personalized or targeted content, and the content distributors may reach customers with known characteristics.

The customization is often produced through manifest manipulation that alters the presentation of the media or playback conditions in manifests defined by streaming standards such as HTTP Live Streaming (HLS) playlists or Dynamic Adaptive Streaming over HTTP (DASH) Media Presentation Description (MPD). Producing personalized manifest for each playback session is especially designed to enable precise targeting of each viewer for improved advertising monetization and/or substituting alternate content after evaluation of the device type or region. With a modest number of customers, the computational burden on the servers providing such personalized manifest manipulation for content is manageable. However, when such personalization is scaled to a substantial number of customers, such as millions of simultaneous customers, the computational burden to provide such video content becomes substantial. By way of an example, such video content may include a live stream of the National Football League Superbowl. To reduce the computational burden and reduce the latency of the video content, it is desirable to reduce the computational demand to provide such content.

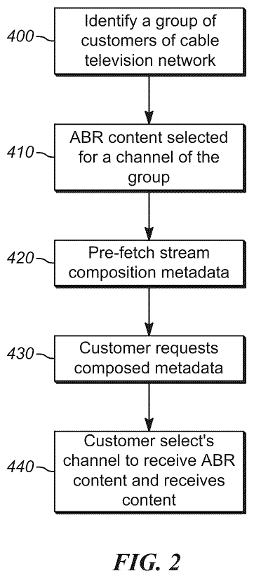

Rather than increasing the number of servers performing the processing to provide the video content, it is desirable to use the characteristics of the cable television network to provide the adaptive bitrate content. Referring to FIG. 2, in particular, for a group of customers within the same geographic region, it may be desirable to provide a shared channel manifest that supports efficient production and distribution of the targeted content to the customers within the same geographic region 400. As an example, a cable operator may be using a multicast ABR (MABR) system to broadcast the media segments from the channel manifests into caches in the clients or gateways in that region. The CMP grouping can produce a shared channel manifest aligning streaming devices in a region with MABR simultaneous requests for the manifest so it may distribute the media into a region for high cache hit rate and bandwidth savings. The CMP may also support hybrid overlays with alternate groups in the region or direct sessions for customers in the same region that use different targeting criteria. Based upon whatever selection criteria are used, the selected channel manifest is produced for the plurality of customers, where the channel manifest is available to each of the customers for efficient download and media distribution through the cable network 400. The channel manifest publisher 105, may make such a determination based upon the content being selected, or likely to be selected, by the customers.

This principle of channel distribution can be provided to HTTP streaming devices streaming video content. Viewers' initial playback requests may include per-client targeting parameters such as region, device type, subscriber profile, or other demographics attributes. The CMP can assign a group of these viewers to a shared channel manifest for more efficient processing of the group. Assigning playback of these viewers onto a common channel manifest URL can allow more efficient distribution through CDN caching. Or simply aligning a group of viewers to share a channel manifest output (may still use personal playback URL) can provide common media segments for efficient multicast distribution to a service group or to a set of receivers joining into a multicast distribution (e.g., multicast ABR (MABR)).

The aligned channel manifests can assist with parity viewing experiences between a traditional cable distribution (QAM) using advertising zones, micro-targeting service groups or SDV, with similar aligned channel manifest with efficient production and distribution to HTTP clients.

The grouping of clients in a region can be based on provisioning, configuration, or other filtered selection. The CMP may provide a channel editor to assist this filtering of criteria for selection of the channel manifest to use and session attributes to be applied. For example, clients in a certain region may receive a channel manifest URL with content produced for that region (e.g., similar to a QAM channel line-up provisioned for distribution into a zone or service group). As another example, clients may use a personal playback URL with per-client header attributes and/or query parameters (e.g., client regional zones, zip code, fipscode, device type, client playback capabilities, subscription type (premium), user demographics for ad targeting, etc.) which are used in filter rules to satisfy that client request with a channel manifest. As another example, the CMP may use the result of a filtered selection to return a redirect (e.g., HTTP 302 status code with a new “location” URL) for clients to switch from a personal playback URL to the selected channel manifest URL.

The system may also dynamically adapt the grouping on channels based on load or system responsiveness. During high volume conditions more viewers can be assigned onto the shared channel (e.g., aggregating viewers into broader targeted grouping or regional zones). The CMP can allow a hybrid model where some demographics or regions are grouped into a more efficient and broader channel manifest, while other channel manifests are deployed to address more narrowly targeted groups. In the limit, some viewers may retain personalized per-client manifest distribution. Examples of adaptive grouping can be policies that manage groups during certain entertainment programs (e.g., during the Superbowl), managing grouping during peak viewing times (evenings and weekends), or introducing higher grouping based on current load thresholds to preserve functionality as system nears limited capacity. A system may combine approaches of configured channel grouping with dynamic conditions for adaptive channel grouping that allow operators to manage the trade-offs in value, costs, and operational needs.

The CMP systems can be chained together to provide cascading functionality. For example, a CMP can publish national/regional ad zones or general device restrictions that can be used as source(s) manifests for use in another CMP system to publish micro-targeted channels to a subset of viewers and possibly act on different set of ad breaks or contact markers. A CMP may also loop upon itself producing a general channel output used as a source manifest for a wide distribution of clients including as a source manifest for other channel outputs. The CMP acts as a server that can be deployed centrally, regionally, or at any location reachable by clients' requests or obtainable by the clients such as through a network gateway. CMP may be deployed as a component integrated into a larger system such as multicast distribution (MABR), content distribution network (CDN) or other manifest distribution systems.

To realize the complete benefits of dynamic channel content, the CMP is typically combined with manifest manipulation functions to generate a custom manifest targeting content for a specific channel (e.g., advertising, alternate content, emergency alert). However, another use case or embodiment may simply manage channel/group assignment to an already existing backend source manifest (e.g., origin source content, JITP, or external manifest manipulator). Although this channel assignment may lack creation of custom targeted content, it may still provide the benefits of dynamic redirect onto a CMP produced channel URL for regional line-up, allow alignment of a group/multicast distribution system (MABR), as a parity channel source URL for QAM distribution systems, or as a method to monitor/track a group of viewers assigned to a passthrough of the origin backend content.

After selection of which content should be provided to a group of customers and the selection of the channel upon which to provide the content, such as the Superbowl on Channel 34, the manifest is pre-fetched 420. The customer then requests the manifest through a proxy URL with channel characteristics 430. The customer by selecting the particular channel where the adaptive bitrate content is being made available may receive the video content 440. As a result, a single session load for video content to the server(s) may serve a large group of customers.

Using such a distribution technique, uniformity of content is sometimes important, e.g., during an emergency alert system event (a system by which emergency notifications may be delivered to viewers), and alternate content and individually tailored streams may be handled identically. By configuring the channel characteristics with the requested entertainment content and target session attributes, the system may associate client requests to a channel, and those requests would get the common stream elements so that they will share the same experience.

Keeping track of player activity to validate advertising or other content that has been consumed typically depends on client behavior to invoke appropriate notifications. This is an issue when the client population may include players that do not support those mechanisms, making an accurate count more complicated. Some purposes are served by the channel manifest publisher itself, which can count the devices making requests to it. However, the channel manifest publisher may not receive all update requests for channel manifest URL cached on a CDN or when manifests are delivered over multicast to a group of users. Accurate counting may be enabled via embedded links such as manifest tags or events containing the tracking beacon URLs, or methods for client to generate tracking from metadata added in the manifest, that cause the client to request information from the channel manifest publisher, which in turn maintains session characteristics for the client and may count active sessions at key points in time, such as at the ad breaks to know viewership at start/end, at the transition between ad spots, or periodically to update number of active viewers. Viewership measurements may be determined using out-of-band accounting such as a simple side connection/session established by client application at tune in that is used to calculate active viewers at the time of an associated event, or with queries into a monitoring or distribution system that returns the listing or counts of the active viewers at the time of the event.

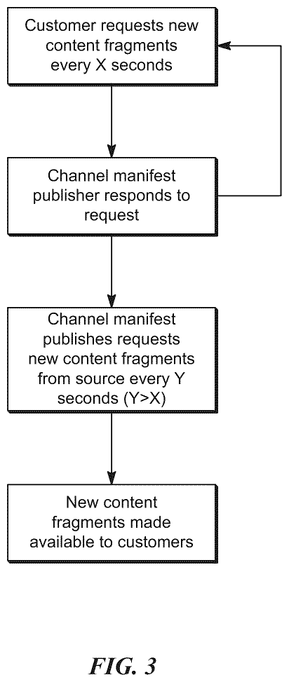

Many manifest manipulation engines, which may be included within the channel manifest publisher, may request content from an origin source with a fixed pre-set temporal interval. While such a consistent pre-set temporal interval ensures the content is timely requested, it tends to place a substantial burden on the server when there are a substantial number of customers. Referring to FIG. 3, it is desirable for the system to include both pre-set temporal intervals and dynamically selected temporal intervals, independently from the normal customer behaviors, which enables fine tuning on the refresh rate to the origin source. For example, a given media protocol may specify that customers should request new content fragments every 2 seconds and should maintain 3 such content fragments in their buffer at any time. Accordingly, the behaviour results in every customer requesting content from the server every two seconds. When the video content is being provided through one of the channels, the requests for new content fragments may be responded to by the channel manifest publisher, while the channel manifest publisher may request content from the origin server(s) 120 and/or CDN 115 at a different temporal rate. For example, the customers may make requests at a 2 second interval which are responded to by the channel manifest publisher, while the channel manifest publisher may make requests at 4 second intervals which are responded to by the origin server(s) 120 and/or CDN 115 and provided to the customers by the selected channel. In this manner, the burden placed on the origin server(s) 120 and/or CDN 115 is substantially reduced. This interval may be decreased to get updated manifests more quickly from the origin server and produce a channel manifest with lower latency to client requests (more quickly publish latest segment). The interval may also be dynamic based on attributes of the source content such as MPEG-DASH MPD @minimumUpdatePeriod (MUP), the HLS playlist TARGETDURATION, or based on the duration of most recent media segment indicating the likely time to expect another segment, or synchronizing requests for updates to the packager segment publishing rate by sporadically being optimistic in requesting manifest until the newest segment is detected and requesting further updates at expected media rate for the ongoing segment durations. It is to be understood that there is no sequential nature to the requests that the clients make to CMP and the requests that CMP makes to the manifest manipulator. There may be two sequences, for example, independent in action but may be coordinated to provide the outputs. The first sequence, for example, is a loop of requests wherein CMP requests a configured URL from MDC, saves the result, waits some interval, and then loops back to make another request. The second sequence, for example, is a loop of client requests, also waiting some interval but not necessarily the same interval, receiving whichever manifest the CMP is currently holding for that network and URL parameters.

Another embodiment may avoid periodic pulling interval by holding open a pending request on the backend awaiting manifest updates while returning the prior cached channel manifest in response to client requests until another update is received. Various protocols may also allow a push method to receive an updated manifest that triggers refresh to the channel manifest content.

The origin server(s) and the channel manifest publisher (which includes metadata manipulation) maintain variants of the media metadata, which may correspond to different bit rates, languages, presentations, or other differences. These variants are used by the supporting devices to support viewer preferences and to adapt to network or device conditions. By way of example for a video session, if the device cannot retrieve the video from a CDN fast enough, it may switch to a lower bit rate presentation that can be retrieved more readily over a limited network. A device may also be CPU-limited, such as a Smart TV with limited processing capabilities, and as a result select a lower bit rate presentation for easier decoding. In one embodiment (e.g. Apple HLS), the channel manifest publisher may optionally retrieve only the content variants that are requested by players. In this case, the first request for a specific variant would begin the process of capturing the metadata content of the specific variant and make it available from the channel manifest publisher. The process of requesting the specific content with a particular variant may later be terminated when no consumers are requesting it. This results in more efficient use of server capacity. In addition, the channel manifest publisher may define a template of policies, which enables a user interface suitable for deployment operation.

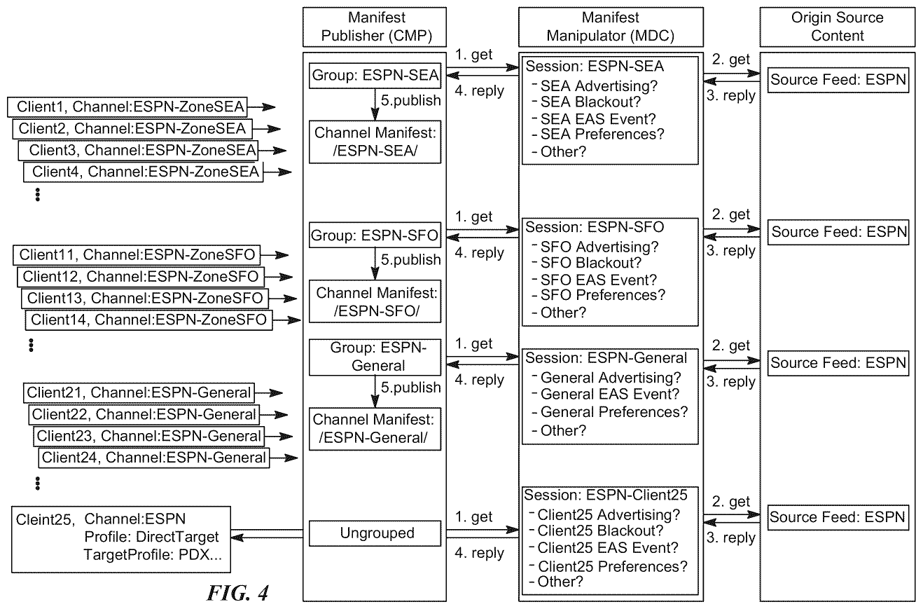

Referring to FIG. 4, an exemplary component diagram (each component may be on the same and/or different device) is illustrated. A group of client players may be desiring to access the same content during a rivalry national football league (e.g. SanFrancisco 49ers vs Seattle Seahawks). The channel manifest publisher can setup grouping for ESPN to the Seattle region (ESPN-SEA), SanFranciso region (ESPN-SFO), and a general region (ESPN-General), and/or allow ungrouped direct targeting for other client profiles. The grouping selection is not illustrated in FIG. 4, but may be the result of a channel line-up given to clients within the region associated with a channel publishing or a redirecting of clients based on regional attributes associated with a channel publishing. For the grouping, the channel manifest publisher provides a “get” request to a manifest manipulator (which may be included as part of the channel manifest publisher) for producing the associated manifest content. The manifest manipulator applies a set of rules to the request, as appropriate, to produce a desired response. The content includes the entertainment content, advertising, blackouts, preferences, emergency messages, etc. The manifest manipulator provides a “get” request to the origin for the source content which responds with a “reply” with information for accessing such content. The manifest manipulator may reply with the actual manifest and the CMP saves or publishes it for distribution to clients that match the grouping assignment. It is to be understood that there is no requirement for sequential relationship between the client requests for published manifests, the “get” request for manifest production, and/or the “get” request for original source content. Caching of a previous manifest may be introduced within or between components. It is noted that in this example the CMP is associated with a broadcast network, where a “channel” is associated with the regional customized content. It is also noted that the actual manifest may be dynamically generated and/or statically generated. It is also noted that the dynamic generation may be based upon an advertising region, which may include, for example, QAM advertising zone distribution, market area, and/or service group. It is to be understood that the content may be entertainment content, other content, video content, and/or audio content. CMP may produce stable known resources (URL) for group distribution that are assigned to the clients based on channel listing or upfront policy rules. The CMP may produce stable known resources (URI) for group distribution that are used by redirect of clients into the group based on dynamic policy rules that adapt to system conditions. The CMP may reuse a prior produced resource (URI) for dynamic expansion of that current distribution group to reduce distribution and production costs for that group of clients. The CMP may resend a prior produced manifest across a set of resources (URIs) for dynamic expansion using cached manifest to reduce manifest production costs for that group of clients.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

I/We claim:

1. A method for selecting streaming content for a customer comprising:
(a) a channel manifest publisher constructing a dynamic grouping of streaming clients each of which receive the same streaming content;
(b) a manifest provider constructing a common corresponding manifest that is used for each dynamic grouping of streaming clients for said streaming content;
(c) providing said streaming content to said dynamic grouping of streaming clients based upon said common corresponding manifest.

2. The method of claim 1 wherein said grouping of streaming clients is dynamically based upon the request for common entertainment content.

3. The method of claim 1 wherein said grouping of streaming clients is dynamically grouped.

4. The method of claim 1 wherein said grouping of streaming clients is statically maintained.

5. The method of claim 1 wherein said dynamic grouping of streaming clients are within a predefined geographic area.

6. The method of claim 1 wherein said dynamic grouping of streaming clients is based upon an advertising region.

7. The method of claim 6 wherein said advertising region is a quadrature amplitude modulation advertising zone distribution.

8. The method of claim 6 wherein said advertising region is a market area.

9. The method of claim 6 wherein said advertising region is a service group.

10. The method of claim 3 wherein said dynamic grouping of said streaming clients is based upon at least one of device type, subscription level, demographics, content interests, and profiles.

11. The method of claim 3 wherein said dynamic grouping of said streaming clients is based upon a parameter in a URI request.

12. The method of claim 1 wherein said streaming content is adaptive bitrate video content.

13. The method of claim 1 wherein said streaming content is adaptive bitrate audio content.

14. The method of claim 1 wherein said channel manifest publisher produces common corresponding manifest to support a multicast adaptive bitrate controller that distributes common media to said dynamic grouping of streaming clients.

15. The method of claim 1 wherein said manifest provider is at least one of a manifest manipulator and a just in time packager.

16. The method of claim 1 wherein said channel manifest publisher assigns said dynamic grouping of streaming clients to a shared channel.

17. The method of claim 1 wherein said dynamic grouping of streaming clients receive said streaming content as at least one of HLS and MPEG-DASH.

18. The method of claim 1 wherein said dynamic grouping of streaming clients supports the channel distribution for service groups that can support QAM or switched digital video.

19. The method of claim 1 wherein said dynamic grouping of streaming clients is selected based upon system performance and/or a corresponding load.

20. The method of claim 1 wherein said channel manifest publisher produces stable known resources for group distribution that are assigned to the clients based upon at least one of a channel listing and existing policy rules.

21. The method of claim 1 wherein said channel manifest publisher produces stable known resources for group distribution that redirect the clients into the group based upon dynamic policy rules.

22. The method of claim 1 wherein said channel manifest publisher produces stable known resources for group distribution that is expanded based upon a cached manifest.
